(19) United States
(12) Patent Application Publication
(10) Pub. No.: US 2026/0131333 A1
(43) Pub. Date: May 14, 2026

(54) SHREDDING DEVICE

(71) Applicant: Komptech GmbH, Frohnleiten (AT)

(72) Inventors: Gerhard KATTINGER, Allerheiligen b. Wildon (AT); Johann NESSHOLD, Stainz (AT)

(21) Appl. No.: 19/202,692

(22) Filed: May 8, 2025

(30) Foreign Application Priority Data
May 8, 2024 (DE) 10 2024 112 941.7

(51) Int. Cl. B02C 18/14; B02C 18/00; B02C 18/18

(52) U.S. Cl. CPC B02C 18/145; B02C 18/0084; B02C 18/18; B02C 2018/188

(57) ABSTRACT

The present invention relates to a shredding device which comprises a shredding roller which has a substantially tubular structure and is rotatable about an axis of rotation, at least one tooth holder fastened to the roller for receiving and fastening a shredding tooth, a shredding tooth which is fastened to the tooth holder of the roller, a counter cutting edge, whose longitudinal axis is oriented in parallel to the axis of rotation of the shredding roller, and at least one cutting plate arranged on the counter cutting edge, which comprises a shredding edge with a contour which, during rotation of the shredding roller, forms a counter-comb to the shredding roller and at least one shredding tooth arranged thereon.

### CROSS REFERENCE TO RELATED APPLICATION

The present application claims priority to German Patent Application No. 10 2024 112 941.7 filed on May 8, 2024. The entire contents of the above-listed application are hereby incorporated by reference for all purposes.

### TECHNICAL FIELD

The invention relates to a shredding device, in particular to a shredding device for shredding waste or wood material.

### BACKGROUND

Shredding devices or shredders in general are crucial for efficient recycling processes, especially when it comes to processing different types of waste and wood material. These machines are designed to break down large volumes of material into smaller, manageable pieces, which not only facilitates transport and storage but also optimizes subsequent steps in material separation and processing. In the recycling sector, shredders are mainly used to process construction waste, garden waste, plastics, paper, metal, and wood material.

### SUMMARY

By shredding wood material waste, for example from forestry or processing of wood material, this material can be effectively recycled to form biomass, mulch, or chipboard. For other materials such as plastics and metals, shredding enables better sorting and cleaning, which is essential for any subsequent recycling steps. Shredding devices are specialized apparatus that are usually tailored to the specific physical properties of the materials to be processed and have a particularly high degree of wear resistance due to their continuous interaction with the material to be shredded.

These machines are designed for durability and efficiency in order to withstand the harsh conditions in waste processing and recycling operations. The use of shredders significantly reduces energy consumption in subsequent processing steps, as the mechanical separation and cleaning of materials is less complex when they are in a homogeneous and reduced size. Shredders therefore play a central role in the recycling cycle and contribute to the efficient use of resources and protection of the environment.

A large number of differently designed shredding devices for shredding biogenic material, for example, are already known from the prior art. So-called screw roller shredders are known, which have a shredding roller or two rollers arranged next to one another and rotating in opposite directions, which are partially covered with screen baskets at the circumference.

The disadvantage of the shredding devices known from the prior art is that they are subject to very high wear due to the demanding nature of their operation and therefore incur relatively high costs over their entire service life due to the regular maintenance and continuous replacement of wear parts.

The object of the present invention is therefore to provide a shredding device that overcomes or at least mitigates the disadvantage described above, for example by more effective processing of the material to be shredded and/or more effective use of the components of a shredding device.

The object is achieved by the subject matter described herein.

The shredding device according to the invention comprises a shredding roller, which has a substantially tubular structure and is rotatable about an axis of rotation, at least one tooth holder fastened to the roller for receiving and fastening a shredding tooth, a shredding tooth fastened to the tooth holder of the roller, a counter cutting edge whose longitudinal axis is oriented in parallel to the axis of rotation of the shredding roller, and at least one cutting plate arranged on the counter cutting edge, which comprises a shredding edge with a contour which, during rotation of the shredding roller, forms a counter-comb to the shredding roller and at least one shredding tooth arranged thereon.

This provides a particularly effective means of shredding since the shredding roller transports the material to be shredded into the area of the counter cutting edge where the shredding is effected. The counter cutting edge is arranged at an angle with respect to the shredding roller so that the at least one cutting plate can be optimally aligned with its shredding edge in order to effectively perform a shredding process on the material to be shredded.

According to an advantageous implementation of the present invention, the counter cutting edge may comprise multiple cutting plates arranged next to one another in the longitudinal direction of the counter cutting edge.

The multiple cutting plates arranged in the longitudinal direction of the counter cutting edge are subject to high wear, since a high force acts here in conjunction with the counter comb defined by the contour of the cutting plate due to the shredding of the material. The use of multiple cutting plates arranged next to one another is advantageous in that if one of the multiple cutting plates is damaged, this cutting plate can be replaced separately without having to replace the entire counter cutting edge. This means that sections of the counter cutting edge that are subject to higher stresses can be replaced as required by changing the corresponding cutting plates, whereas sections of the counter cutting edge that are subject to less stress can be used for longer with their respective cutting plates.

After an optional modification of the present invention, it may be provided that the cutting plate has an essentially plate-like basic structure, the planar side of which has rotational symmetry, in particular bilateral or quadrilateral rotational symmetry, in order to be able to arrange a second usable shredding edge when rotating about the axis of rotation, preferably wherein turning from a first planar side to a second planar side results in a doubling of the available shredding edges available on a first of the two planar sides of the plate-like basic structure of the cutting plate.

The cutting plate therefore not only has one cutting edge, but also rotational symmetry, so that after rotation of the planar side of the cutting plate about an axis of rotation extending in the thickness direction of the cutting plate, there is at least one further identically—designed cutting edge which can be used after wear of the first cutting edge of the cutting plate. In addition, the cutting plate can also be a reversible cutting plate, so that when rotated about an axis of rotation oriented perpendicular to the thickness direction of the cutting plate, i.e., when changing from an upper to an underside of the cutting plate, at least one further cutting edge is available. Turning the cutting plate thus doubles the number of cutting plates available on a first of the two planar sides of the cutting plate.

According to a further optional development of the present invention, it may be provided that a cutting plate is held in the counter cutting edge by a clamp, and preferably a positioning groove is provided in the cutting plate for correct alignment of the at least one cutting plate relative to the counter cutting edge.

Clamping the cutting plate in the counter cutting edge and providing an optional positioning groove in the cutting plate for correct positioning in the counter cutting edge results in correct and simple arrangement of the cutting plate in the counter cutting edge, which also allows quick replacement or change of the corresponding cutting edge. Finally, only the clamping needs to be released and the cutting plate replaced or turned so that an unused cutting edge can then be used to shred the material.

Advantageously, the positioning groove can be provided on both planar sides of the shredding edge and/or the positioning groove can be designed so that the center point through which the axis of symmetry (perpendicular to a planar side of the cutting plate) passes is also arranged therein.

By providing the positioning groove on both planar sides, it is not necessary to adjust the clamping device even after the cutting plate has been turned, since the elements engaging in the positioning groove can remain in the same place.

According to an advantageous further development of the present invention, it may be provided that the counter cutting edge is movable in the radial direction relative to the shredding roller and can be fixed in the radial direction relative to the shredding roller by means of a locking means in order to be able to adjust a cutting gap between the shredding roller and the counter cutting edge.

This allows the cutting gap between the outer contour of the shredding roller and the contour of the counter cutting edge facing the roller to be adjusted as required, so that the size of the material obtained after shredding can be adjusted according to the requirements of the situation. In addition, after a certain operating time of the shredding device, wear of the shredding teeth or the cutting edges of the cutting plate may cause the cutting gap to become too large, which can be reduced to a normal size by moving the counter cutting edge toward the shredding roller.

Corresponding locking means are provided to lock the counter cutting edge, for example by means of pressure and draw bolts, which allow relative movement of the counter cutting edge or the cutting plate(s) toward or away from the roller.

According to an optional modification of the present invention, it may be provided that the counter cutting edge for each of the at least one cutting plate has a clamping device for fixing the cutting plate in the counter cutting edge, wherein the clamping device is implemented by two clamping jaws which are designed to clamplingly receive the cutting plate.

It may be advantageous to provide that each of the two clamping jaws of the clamping device has an elevation corresponding to a positioning groove in the cutting plate in order to provide for precise positioning of the cutting plate in the clamping jaw.

According to a further advantageous implementation of the present invention, a guide plate extending along the longitudinal direction of the counter cutting edge may be provided on an upper side of the counter cutting edge, which serves to guide material to be shredded to the shredding roller.

The guide plate can extend over the entire length of the counter cutting edge and be oriented such, that when a material moves in the direction of rotation of the shredding roller, the material to be shredded is guided toward the rotating surface of the shredding roller.

Typically, this is achieved by inclining the guide plate so that the material to be shredded is moved toward the counter cutting edge and the surface of the shredding roller.

Furthermore, according to the present invention, it can be provided for the device to comprise a base frame for receiving the shredding roller and the counter cutting edge.

The shredding roller and also the counter cutting edge can be arranged on a base frame, but the counter cutting edge is movable, in particular with respect to the direction of rotation of the shredding roller, in order to be able to variably adjust a cutting gap.

Advantageously, it may be provided for the base frame to have a substantially box-like shape, which has an opening at its upper side for supplying material to be shredded.

This is a particularly simple design for supplying material to be shredded, since this material can simply be introduced from above into the opening for supplying it to the shredding device and the rotation of the shredding roller and the corresponding arrangement of the counter cutting edge automatically cause the material to be shredded to be conveyed to the counter cutting edge.

Further details and advantages of the invention are explained in greater detail with reference to the exemplary embodiment shown in the drawings.

### BRIEF DESCRIPTION OF THE FIGURES

The figures show in:

FIG. 1 a perspective illustration of a shredding device according to the present invention,

FIG. 2 a top view of a shredding device according to the present invention,

FIG. 3 a top view of the shredding roller and counter cutting edge without base frame,

FIG. 4 a cross-sectional view of the shredding roller and counter cutting edge,

FIG. 5 a perspective illustration of the shredding roller and counter cutting edge,

FIG. 6 a perspective illustration of the counter cutting edge, and

FIG. 7 a perspective illustration of the cutting plate from the counter cutting edge.

### DETAILED DESCRIPTION

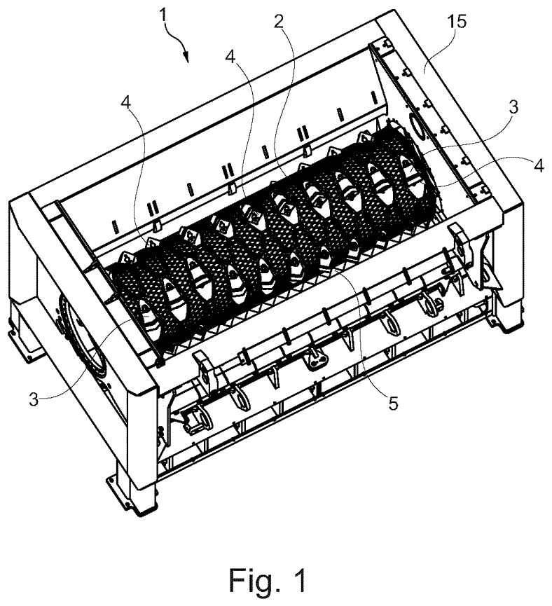

FIG. 1 shows the shredding device 1 according to the present invention. It has an input opening provided on the upper side through which the material to be shredded is introduced. Below said opening is located a shredding roller 2 which, in interaction with a counter cutting edge 5, results in the shredding of material conveyed from the shredding roller 2 towards the counter cutting edge 5. The shredding roller 2 and the counter cutting edge 5 are fixedly arranged on a base frame 15 so that even when large forces are exerted, the shredding roller 2 or counter cutting edge 5 do not move back. The material crushed in this way then falls through an outlet opening arranged at the bottom, from where the crushed or shredded material can then be conveyed away for further processing.

The shredding roller 2 is equipped with multiple shredding teeth 4, each of which is fastened to the shredding roller 2 via a tooth holder 3. Part of the shredding tooth 4 protrudes radially from the shredding roller 2 and ensures that material to be shredded interacting with the roller 2 is conveyed in accordance with the direction of rotation of the roller. The counter cutting edge 5 has a contour forms a counter-comb to the shredding roller 2 equipped with the shredding teeth 4, so that when the shredding roller 2 rotates, the shredding teeth 4 are moved past the contour of the counter cutting edge 5, in particular the shredding edge 7 of the cutting plate 6, at approximately the same distance. This distance is also referred to as the cutting gap S and can be adjusted by means of an adjustment device by moving the counter cutting edge 5 radially toward or away from the shredding roller 2.

The base frame 15 of the shredding device 1 is of approximately cuboid design and can be moved by means of a chassis 13 or be fixed to a base. However, the chassis on which the shredding device 1 is arranged may also have a crawler drive or any other type of chassis.

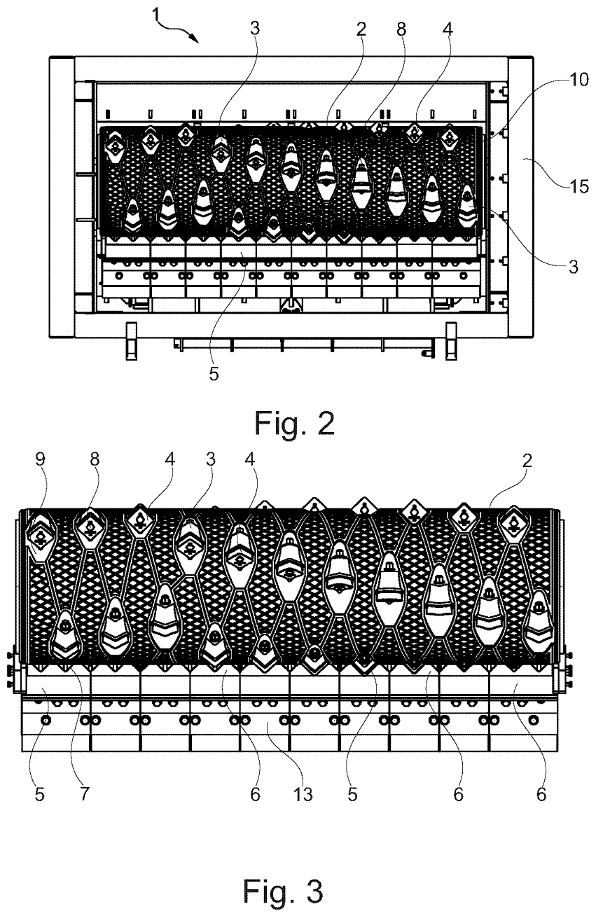

FIG. 2 shows a top view of the shredding device 1, in which the shredding roller 2 with its shredding teeth 4 and the counter cutting edge 5 can be seen through the opening for feeding in the material to be shredded. It can also be seen that each shredding tooth 4 has a corresponding tooth holder 3 which can receive a respective shredding tooth 4 by means of a screw connection 8.

The outer contour of the shredding roller 2 is provided with a lattice-like plating 10, which improves the conveyance of the material to be shredded in accordance with the direction of rotation of the shredding roller 2. The lattice structure ensures that the material to be shredded becomes wedged in the lattice structure so that, in conjunction with the shredding teeth 4, a high force is exerted to push the material to be shredded toward the counter cutting edge 5. There, the material is broken or cut, as the counter comb prevents unshredded material from passing through to the underside of the shredding roller 2 and only allows components to pass through that are typically significantly smaller than the initial size of the material to be shredded. The size of the output material obtained after processing by the shredding device 1 can be varied by adjusting the cutting gap S, which defines the distance between the counter cutting edge 5 and the outer contour of the shredding roller 2.

FIG. 3 is a top view of the shredding roller 2 and the counter cutting edge 5, wherein the base frame 15 and the other components of the shredding device 1 are not illustrated for reasons of clarity.

It can be seen that the shredding teeth 4 arranged along the longitudinal axis of the shredding roller 2 are adapted to the contour of the counter cutting edge 5, whose longitudinal axis is parallel to the axis of rotation of the shredding roller 2, so that when the shredding roller 2 rotates, each of the multiple shredding teeth 4 can be guided past the counter cutting edge 5 without coming into contact with it.

Since each of the multiple shredding teeth 4, the shredding edges of the cutting plates 6, and the counter cutting edge 5 are subject to high wear, they can be replaced. For this purpose, each of the shredding teeth 4 is fastened to a tooth holder 3 by means of a screw or bolt fastening 8, so that the shredding teeth 4 can be replaced if they are damaged or excessively worn. The same applies to the elements of the counter cutting edge 5 that are subject to high wear, since here too the cutting plate 6 can be replaced or the shredding edge 7 provided on the cutting plate 6 can be changed by turning or rotating the cutting plate 6.

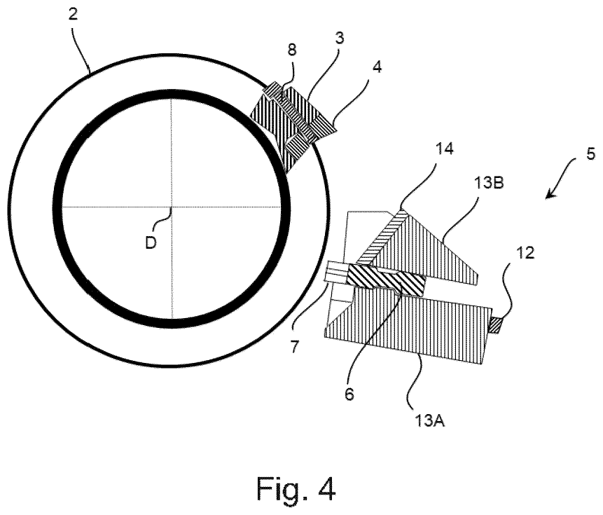

FIG. 4 is an enlarged view of a cross-section of the shredding roller 2 and counter cutting edge 5, in which the fastening of the tooth holder 3 to the roller 2 is clearly discernible. Advantageously, the tooth holder 3 is welded to a component of the shredding roller 2 so that no relative movement of the tooth holder 3 with respect to the shredding roller 2 occurs. The tooth holder 3 has an indentation 9 relative to an outer contour of the shredding roller 2 or a plating 10, so that a shredding tooth 4 fastened to the tooth holder 3 protrudes outwardly from the outer surface of the shredding roller 2. The screw fastening 8 of the shredding tooth 4 on the tooth holder 3, which ensures that the shredding tooth 4, which is subject to high wear, can be replaced, can also be seen.

The counter cutting edge 5 comprises the cutting plate 6 with its at least one shredding edge 7 and a clamping device 13 for fastening the cutting plate 6. The clamping device 13 comprises two clamping jaws 13A, 13B which ensure that the cutting plate 6 is positioned in place in the counter cutting edge 5. In order to be able to vary a cutting gap S, which defines a distance between the contour formed by the counter cutting edge 5 and the shredding teeth 4 or the outer contour of the shredding roller 2, the position of the cutting plate 6 can be varied by means of pressure and draw bolts 12. For example, if the screw 12 is turned in one direction or the other, this causes the cutting plate 6 to move toward or away from the shredding roller 2.

It can also be seen that the counter cutting edge 5 also has a guide plate 14 in an upper region for supplying the material to be shredded in the direction of the cutting gap, so that effective breaking or crushing of the material results.

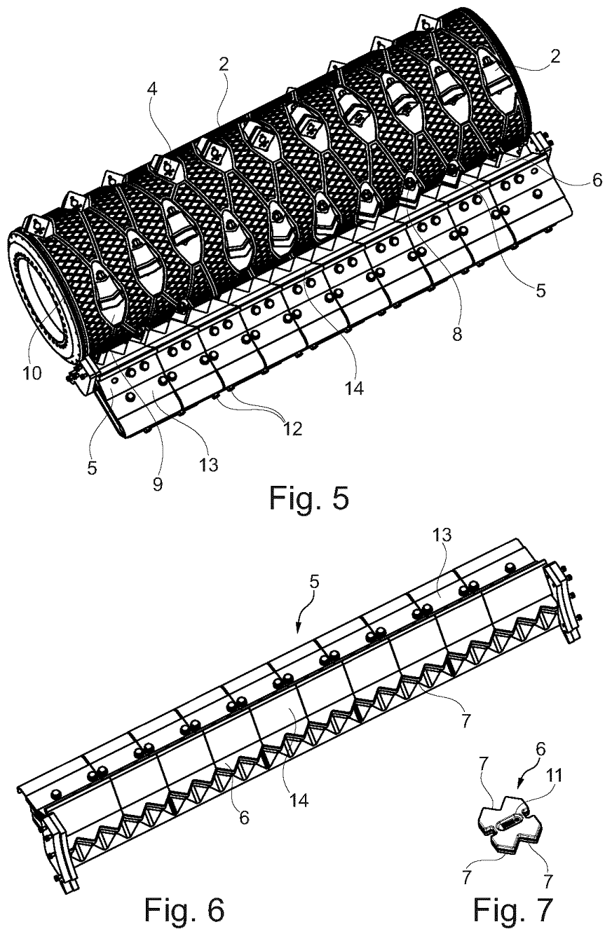

FIG. 5 shows a perspective illustration of the shredding roller 2 and counter cutting edge 5, in which the guide plate 14 and the clamping device 13 with its clamping screws can be seen.

FIG. 6 is a perspective illustration of the counter cutting edge 5 from another side, so that the side of the counter cutting edge 5 normally facing the shredding roller 2 can be seen. The guide plate 14 and the multiple cutting plates 6 arranged next to one another with their respective protruding upper cutting edges 7 can be seen.

FIG. 7 is a view of the cutting plate 6 with multiple cutting edges/shredding edges 7 located thereon. For secure fastening of the cutting plate 6 in the clamping device, the cutting plate 6 has a positioning groove 11 which, in cooperation with corresponding projections of the two clamping jaws 13A, 13B to ensure stable positioning in the clamping device 3. If one of the multiple shredding edges 7 of the cutting plate 6 is worn, the cutting plate 6 can be rotated by loosening the associated screw connection so that another shredding edge 7 is now facing the outer contour of the shredding roller 2. Alternatively, it is possible to turn the cutting plate 6 so that the shredding edge 7, which was previously facing an underside, is now facing upwards and is subjected to a wear process when the shredding roller 2 is operated in its direction of operation. In total, four different shredding edges 7 are provided on the cutting plate 6 shown in FIG. 7, so that the cutting plate 6 only needs to be replaced when all four shredding edges 7 are worn.

### LIST OF REFERENCE NUMERALS

1 Shredding device
2 Shredding roller
3 Tooth holder
4 Shredding tooth
Counter cutting edge
6 Cutting plate
7 Shredding edge
8 Screw or bolt fastening
9 Indentation
Plating
11 Positioning groove
12 Locking means
13 Clamping device
13A Clamping jaw
13B Clamping jaw
14 Guide plate
Base frame
D Axis of rotation of the shredding roller
S Cutting gap between counter cutting edge and shredding roller

1. A shredding device, comprising:
a shredding roller which has a substantially tubular structure and is rotatable about an axis of rotation,
at least one tooth holder fastened to the roller for receiving and fastening a shredding tooth,
the shredding tooth fastened to the tooth holder of the roller,
a counter cutting edge whose longitudinal axis is oriented in parallel to the axis of rotation of the shredding roller, and
at least one cutting plate arranged on the counter cutting edge, which comprises a shredding edge with a contour which, during rotation of the shredding roller, forms a counter-comb to the shredding roller and at least one shredding tooth arranged thereon.

2. The shredding device according to claim 1, wherein the counter cutting edge comprises multiple cutting plates arranged next to one another in a longitudinal direction of the counter cutting edge.

3. The shredding device according to the preceding claim 2, wherein the multiple cutting plates arranged next to one another are located in a common plane.

4. The shredding device according to claim 1, wherein the at least one cutting plate has an essentially plate-like basic structure, a planar side of which has rotational symmetry, in order to be able to arrange a second usable shredding edge upon rotation about the axis of rotation.

5. The shredding device according to claim 4, wherein turning from a first planar side to a second planar side of the at least one cutting plate results in doubling of the number of available shredding edges available on a first of the two planar sides of the plate-like basic structure of the at least one cutting plate.

6. The shredding device according to claim 1, wherein the at least one cutting plate is received in the counter cutting edge by clamping.

7. The shredding device according to claim 1, wherein a positioning groove is provided in the at least one cutting plate for correct alignment of the at least one cutting plate relative to the counter cutting edge.

8. The shredding device according to claim 7, wherein the positioning groove is designed such that a center point through which an axis of symmetry of the planar side of the at least one cutting plate passes is also arranged therein.

9. The shredding device according to claim 8, wherein the positioning groove of a first planar side is arranged at the same position as the positioning groove of a second planar side of the at least one cutting plate.

10. The shredding device according to claim 1, wherein the counter cutting edge is movable in a radial direction relative to the shredding roller and can be fixed in the radial direction relative to the shredding roller by means of a locking means in order to be able to adjust a cutting gap between the shredding roller and the counter cutting edge.

11. The shredding device according to claim 1, wherein the counter cutting edge comprises a clamping device for each of the at least one cutting plate in order to fix the at least one cutting plate in the counter cutting edge, wherein the clamping device is implemented by two clamping jaws which are designed to clampingly receive the at least one cutting plate.

12. The shredding device according to claim 11, wherein each of the two clamping jaws of the clamping device has an elevation corresponding to a positioning groove in the at least one cutting plate in order to provide precise positioning of the at least one cutting plate in the clamping jaws.

13. The shredding device according to claim 1, wherein a guide plate extending along a longitudinal direction of the counter cutting edge is provided on an upper side of the counter cutting edge, which plate serves to guide material to be shredded to the shredding roller.

14. The shredding device according to claim 1, further comprising a base frame for receiving the shredding roller and the counter cutting edge.

15. The shredding device according to claim 14, wherein the base frame essentially has a box shape which has an opening on its upper side for supplying material to be shredded.

16. The shredding device according to claim 4, wherein the rotational symmetry is bilateral rotational symmetry.

17. The shredding device according to claim 7, wherein the positioning groove is provided on both planar sides of the at least one cutting plate.
